(19) United States
(12) Patent Application Publication
(10) Pub. No.: US 2001/0027556 A1
(43) Pub. Date: Oct. 4, 2001

(54) Information processing device with a television display function and a small display device

(76) Inventors: Toshio Shimosako, Tenri-Shi (JP); Sadahiko Hinoue, Nara-Shi (JP)

Correspondence Address: BIRCH, STEWART, KOLASCH & BIRCH, LLP, P.O. BOX 747, Falls Church, VA, 22040-0747, US

(21) Appl. No.: 09/753,668

(22) Filed: Jan. 4, 2001

(30) Foreign Application Priority Data
Mar. 31, 2000 (JP) 2000-098853

(51) Int. Cl. H04N 7/16

(52) U.S. Cl. 725/1

(57) ABSTRACT

An information processing device with a TV function, which is capable of visually presenting information necessary for a viewer when viewing a TV picture on a main display screen. A power supply control IC discriminates which switch button is pressed for the information processing device or the TV. When the switch button for TV was pressed and start control is turned ON only for the TV, the power supply control IC supplies electric current to only the TV function block and sets a TV tuner and a NTSC decoder. It sets a display controller and an amplifier portion so that display data and sound data of the TV function block can be output. The power supply control IC manages and converts the current TV channel number and channel information into displayable codes and sends the codes to a display controller that in turn internally develops the received code on a bitmap and display the codes on a small display device.

### BACKGROUND OF THE INVENTION

The present invention relates to an information processing device provided with a television display function.

In the prior art, a television display function included in an information processing device is realized as a particular application of the information processing device or a separate TV display function acting independently of the information processing device.

The TV displaying function to be used as a particular application of the information processing device is first described bellow.

FIG. 1 is a block diagram showing an exemplary construction of an information processing system wherein its TV display function is realized as a particular application.

In FIG. 1, the system comprises a central processing unit (CPU) 1 for controlling a whole system, a CHIP SET 102 for connecting the CPU 101 with other logic circuits, a main memory 103 for storing programs and data under the control of the CPU 101, a BIOS (basic I/O system) 104 including basic operation settings and programs of the information processing device, which settings and program are read when the power supply is switched ON, a power supply control IC 105 for controlling the power supply portion of the information processing device, which control IC is a first acting logic composed of a one-chip microcomputer, a display controller 106 being a control logic when the information processing device performs the display operation, a video memory 107 for storing display data under the management by the display controller 106, which memory 107 may be incorporated in the display controller 106 and/or may be used in common with the main memory 103.

The system also includes a storage device 108 for storing large capacity programs and operating systems, which consists of a hard disk (HDD) and/or a large capacity flash memory, a sound LSI (large-scale integrated circuit) 107 which is a logic for controlling sound input/output of the information processing device, other circuit 110 which includes input devices such as a keyboard, mouse and the like and input/output device interface portions such as parallel, serial and USB interfaces, a TV tuner 111 which separates a selected frequency range of an antenna input into video signal and sound signal and outputs them, a NTSC decoder 112 for converting a video signal from the TV tuner 111 into digital data that can be processed by the information processing device, an input device 113 including a keyboard, mouse, remote controller and the like means to be used by the user, a display device 114 including a CRT and a LCD to be viewed by the user and a power supply switch 115 to be used by the user for operating the power supply of the information processing device.

Referring to FIG. 1, the operation of the information processing device provided with the TV display function according to the present invention is described below.

When the power supply switch 115 is switched ON, the power supply IC 105 supplies electric power to relevant blocks of the information processing device, the CPU 101 reads the BIOS 104, performs initial settings of the blocks and controls the blocks through the CHIP SET 102. Some times, the CPU 101 reads all the content of the BIOS 104 through the CHIP SET 102 and stores it in the main memory 103.

Then, the CPU actuates a boot-operating system (Boot-OS) incorporated in the storage device 108.

On completion of activation of the OS, it becomes possible to execute any application stored in the storage 108 becomes possible.

When the input device 113 is operated under the above conditions, the CPU 101 through the other circuit 110 and CHIP SET 102 puts interpretation on the input and reads a TV-display application program from the storage device 108 into the main memory 103. According to the program, the CPU 101 controls the TV tuner 111, the NTSC decoder 112, the sound chip 109 and the display controller 106 to transfer TV video data to the display controller 106 and TV sound data to the sound chip 109, thereby the user can view the TV video with a sound signal on the display screen.

Although the shown system transfers video data to the display controller 106 through the CHIP SET 102, another system may transfer the video data directly to the display controller 106 from NTSC decoder.

A method for operating the TV function independently of the image information device is described below.

FIG. 2 illustrates an exemplary construction of an information processing system wherein a conventional TV display function is realized independently of the information processing device.

The system is composed mainly of an information processing device 200 and a display device 220. The operation of the information processing device 200 to run the TV display application is omitted since it is similar to that described with reference to FIG. 1.

The display device 200 is composed of the following blocks:

A TV tuner 221 that separates a selected frequency range of an antenna input to a video signal and a sound signal from each other and outputs separate signals;

A NTSC decoder 222 for converting a video signal from the TV tuner 221 into digital data that can be processed by the information processing device;

A display/system control portion 223 that controls a whole system of the display device 220, the display operation and switching of display input;

A display device 224 that is a CRT or a LCD viewable by the user;

An amplifier portion 225 that is a logic for amplifying a sound output of the display device 220; and

An input device 226 that is a switch, remote controller and the like devices to be operated by the user.

The operation of the above device is as follows:

When the user switched ON the display device 220 by using the input device 226, the display/system control portion 223 performs settings for the TV tuner 221, NTSC decoder 222 and amplifier portion 225, receives video through the TV tuner 221 and NTSC decoder 222, converts the video to a suitable display format for the display portion 224 and outputs the video data to the display portion 224 that in turn displays the TV picture.

Sound data from the TV tuner 221 is amplified by the amplifier portion 225 and then output through a speaker.

To display the data from the information processing device, the user operates the input device 226 to change the output of the display/system control portion 223 to the data from the information processing device.

Although the operation of the system has been described with the TV display being ON, it may be preset that the TV display or the information display, which was displayed at the time of turning off the power supply, is selected by the priority when turning on the power supply. However, it is also possible to program the priority to be given to information display of the information processing device or TV display when turning on the power supply of the system. It is further possible to allow the user to select the display when turning on the power supply.

The above-described prior arts, however, are inconvenient for users since the starting state of the information processing device and information on a channel, sound volume and an input source cannot be monitored in case when display screen is entirely occupied by a TV picture.

Even in case of displaying TV on a part of the display screen, it is still difficult or sometimes impossible to see the channel, volume and input-source information. In this regard, the prior arts cannot satisfy the users' requirements.

### SUMMARY OF THE INVENTION

An object of the present invention is to provide an information processing device that is directed to make it possible for viewers to visually recognize information that is necessary but cannot be viewed on a display according to the prior arts.

Another object of the present invention is to provide an information processing device capable of displaying TV video, which is provided with means for discriminating which power supply for Information display or TV display is turned ON, means for separately controlling the power supply for an information processing block and the power supply for a TV functioning block, means for setting how to start and control of the system when the TV block power supply is turned ON, means for storing the settings of how to start and control when the TV block power supply is turned ON and means for switching the display to TV display or information processing device display and displaying the TV video or the processed information.

Another object of the present invention is to provide an information processing device capable of displaying TV video, which is further provided with a small display device other than a display device for information processing function/TV function, means for controlling the small display device and means for transmitting the operating/starting state information to a control portion of the small display device, wherein, when the discriminating means recognized the ON state of the power supply for TV display, the operating state and the starting state of the information processing device are displayed for the user on the small display device.

Another object of the present invention is to provide an information processing device capable of displaying TV video, which is further provided with a small display device in addition to a display device for information processing function/TV function, means for controlling the small display device and means for transmitting TV channel number/channel information to a control portion of the small display device, wherein the number and relevant information of the channel selected by the TV display is displayed for the user on the small display device.

Another object of the present invention is to provide an information processing device capable of displaying TV video, which is further provided with a small display device in addition to a display device for information processing function/TV function, means for controlling the small display device and means for transmitting information on plural input-sources for plural TV outputs to a control portion of the small display device, wherein the information of the input source selected by the TV display is displayed for the user on the small display device.

A further object of the present invention is to provide an information processing device capable of displaying TV video, which is further provided with a small display device in addition to a display device for information processing function/TV function, means for controlling the small display device and means for transmitting TV sound volume information to a control portion of the small display device, wherein the information of the sound volume selected by the TV display is displayed for the user on the small display device.

A still further object of the present invention is to provide an information processing device capable of displaying TV video, which is further provided with a small display device in addition to a display device for information processing function/TV function, means for controlling the small display device, means for selecting a content of information to be displayed on the small display device, means for transmitting the operating state and the starting state of the information processing device to a control portion of the small display device, means for transmitting TV channel number/channel information to the control portion of the small display device and means for transmitting information on an input source selected for the TV output among a plurality of input sources to a control portion of the small display device, wherein the selected information content is displayed for the user on the small display device.

### BRIEF DESCRIPTION OF THE DRAWINGS

FIG. 1 is a construction block diagram of an exemplary information processing system including a conventional television display function to be effected as a particular application of the information processing device.

FIG. 2 is a construction block diagram of an exemplary information processing system including a conventional television display function to be effected independently of the information processing device.

FIG. 3 is a construction block diagram of an exemplary information processing device with a television display function according to the present invention.

FIG. 4 is a block diagram showing a detailed construction of a display controller of FIG. 3.

FIG. 5 is a block diagram showing a detailed construction of a power supply control IC of FIG. 3.

FIG. 6 is a flowchart depicting the processing steps for an information processing device with a television display function according to the present invention.

### PREFERRED EMBODIMENT OF THE INVENTION

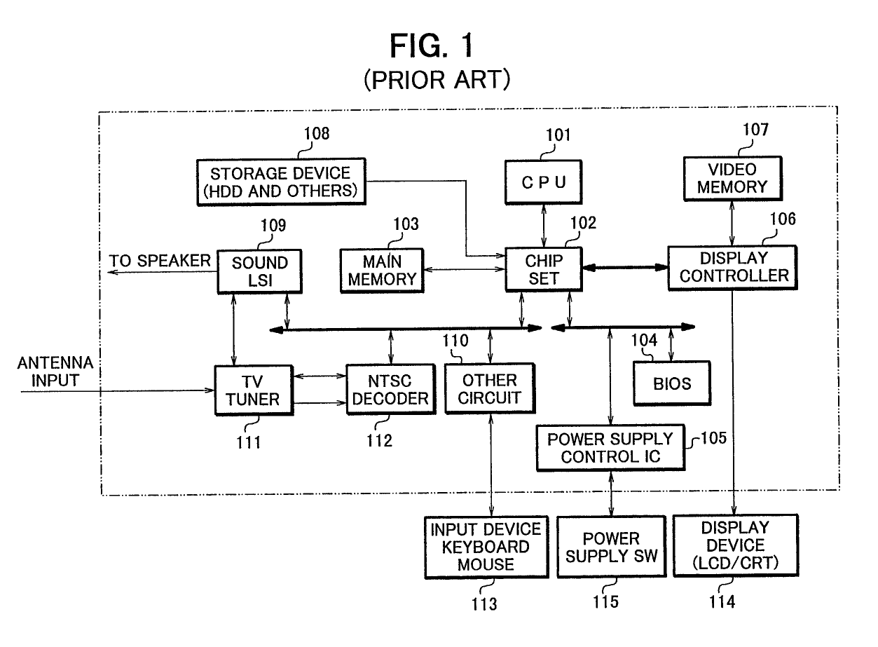

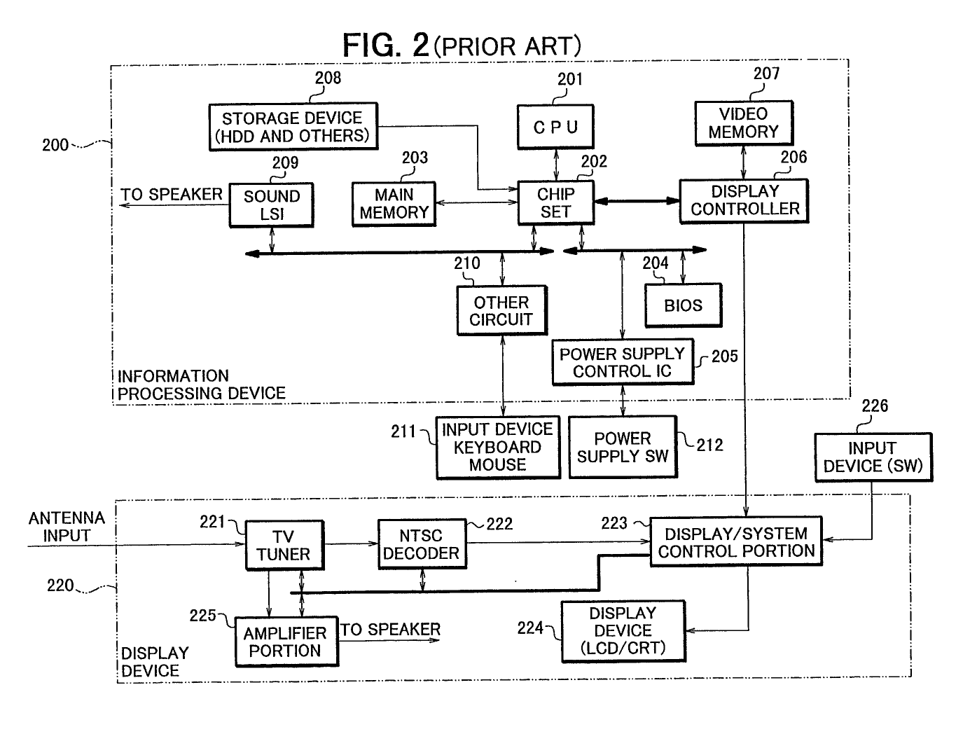

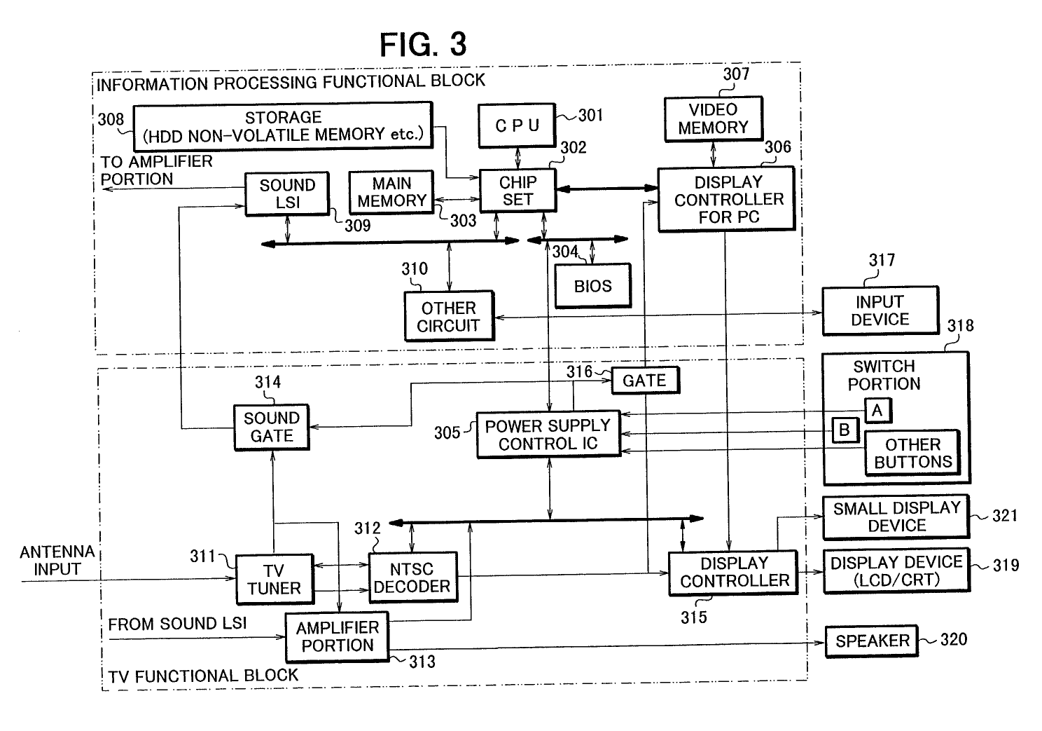

FIG. 3 is a construction block diagram of an information processing device provided with a TV display function according to the present invention. The information processing device according to the present invention is composed mainly of an information processing function block and a TV function block. The construction of each block is described below, omitting the detailed description of components common to those described for the prior arts of FIGS. 1 and 2.

Numeral 301 designates a CPU, 302 a CHIP SET, 303 a main memory, 304 a BIOS, 305 a power supply control IC, 306 a display controller for a PC, 307 a video memory, 308 a storage device, 309 a sound LSI, 310 other circuit, 311 a TV tuner, 312 a NTSC decoder and 313 an amplifier portion.

Numeral 314 designates a sound GATE for determining whether it is needed or not to output sound data from the TV tuner 311 to the sound LSI 309.

Numeral 315 designates a display controller that includes a converting circuit for converting display data for respective display devices to be described later and controls the operation of a display input changeover switch.

Numeral 316 is a GATE for determining whether it is needed to output video data from the NTSC decoder 312 to the PC display controller 306.

Numeral 317 denotes an input device, 318 a power supply switch, 319 a display device and 320 a speaker.

Numeral 321 designates a small display device that may be a LED or LCD.

The display controller 315 is described in detail below.

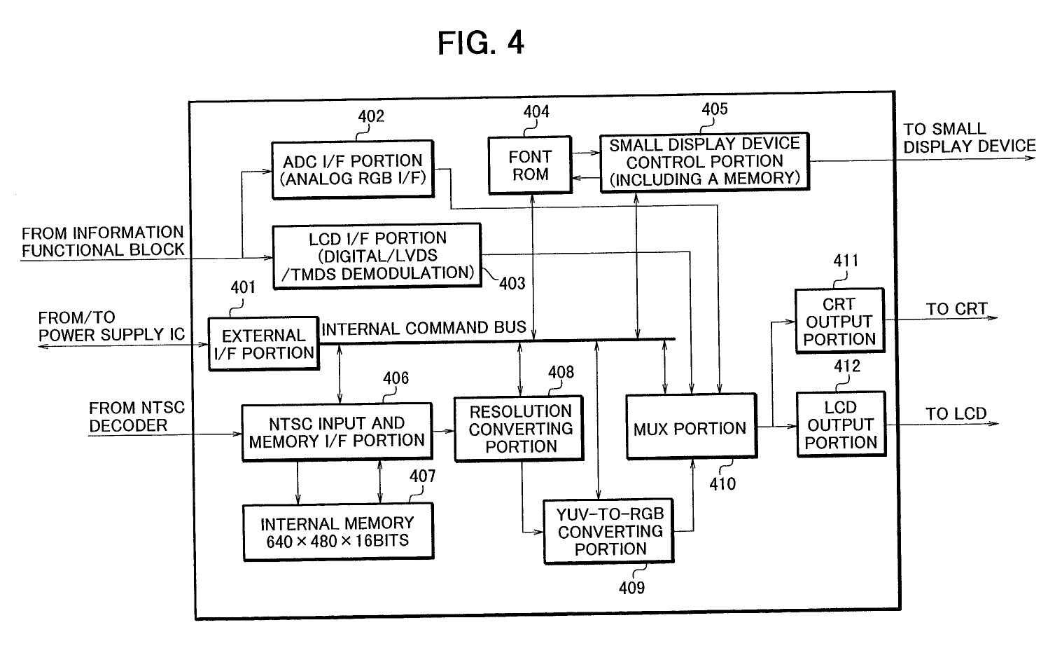

FIG. 4 is a detailed construction block diagram of the display controller shown in FIG. 3.

Numeral 401 designates an external interface (I/F) through which the display controller exchanges commands with the power supply IC 305.

Numeral 402 designates an analog-digital converter interface (ADC I/F) that, when display data from the information processing function block is output in the form of analog RGB signals, is used for converting the input analog data of RGB, HS, VS into digital data of RGB, HS, VS and display CLK (clock).

Numeral 403 is a LCD interface (I/F) portion for use in case when display data output from the information processing function block is for LCD, which interface converts input signals into digital signals of RGB, Hsync, Vsync, Dispen and DOTCLK. An input method may be of TMDS system, LVDS system and direct digital RGB system, etc., which may be selected by a logic (e.g., an external terminal of the LSI).

Numeral 404 is a FONT memory storing fonts of characters and symbols, etc., to be used by the small display control portion 405 to be described later. This memory may be a ROM or a flash memory.

Numeral 405 designates a small display control portion that controls the process of displaying codes transmitted through the external interface 401 on the small display device 321. It generates display-timing signals, converts the transmitted code into characters and symbols using the font memory and outputs the converted data as display data to be displayed on the small display device.

Numeral 406 designates a NTSC input/memory interface I/F portion that has a function for writing digital data (using YUV data to save data amount) from the NTSC decoder 312 into an internal memory 407 (to be described later) and has a function for reading the YUV data from an internal memory 407 at the output timing and outputting the YUV data to are solution converting portion 408 (to be described later). This portion can be controlled externally through an external interface 401 and an internal bus in regard to its reading coordinates and reading rate.

Numeral 407 designates an internal memory that stores therein data of 2-frames, each including Y (luminance) data of 640×240×8, U and V (4-color difference) data of 320×240×8. This memory may be attached externally to the information processing device.

Numeral 408 designates a resolution converting portion composed of logics for performing the conversion of the input YUV data to any suitable resolution. The resolution conversion may be performed by any selected method (e.g., a linear interpolation method) at a preset output resolution for 640×240. Thus, the resolution conversion method and the output resolution may be externally controlled through the external interface 401 and the internal bus.

Numeral 409 designates a YUV-to-RGB converting portion that is composed of logics for converting input YUV data into RGB data that can be displayed on a CRT or a LCD. Coefficients of the YUV-to-RGB conversion may be controlled externally through the external interface 401 and the internal bus.

Numeral 410 designates a multiplexer (MUX) portion that synthesizes RGB data from the ADC I/F portion 402, LCD I/F portion 403 and YUV-to-RGB converting portion 409, selects and outputs the data. This portion may be externally controlled in relation a range of coordinate values and a method for outputting the data through the external interface 401 and the internal command bus.

Numeral 411 designates a CRT output portion that is a logic for converting data into analog data to be output to the CRT.

Numeral 412 designates a LCD output portion that logically converts data into data to be output to the LCD and logically (using the external terminal of LSI) selects one of conversion methods TMDS, LVDS and direct digital RGB.

Next, the case of directly outputting LCD display data from the information processing function block is described below. A command from the power control integrated circuit (IC) 305 through the external interface portion 401 and the internal command bus is transmitted to each block. The LCD interface portion 403 converts data into digital RGB data, the multiplexer portion 410 selects signals from the LCD interface portion 403 at all coordinates, transfers the signals to the LCD output portion 412 that in turn outputs the signals to the LCD.

The case of displaying data from the NTSC decoder 312 on a whole screen of the LCD is described below. A command from the power control integrated circuit (IC) 305 through the external interface 401 and the internal command bus is transmitted to each block. The NTSC input/memory interface portion 406 writes YUV data in the internal memory 407, reads data from the internal memory 407 in accord with a vertical sync and a horizontal sync for resolution conversion and outputs the data to the resolution converter 408.

The resolution converting portion 408 performs resolution converting operation on input data of 640×240 and outputs the converted data to the YUV-to-RGB converting portion 409 that in turn converts the YUV data into the RGB data. Then, the multiplexer portion 410 selects signals from the YUV-to-RGB converting portion 409 at all coordinates and transfers the selected signals to the LCD output portion 412 that in turn outputs the signals to the LCD.

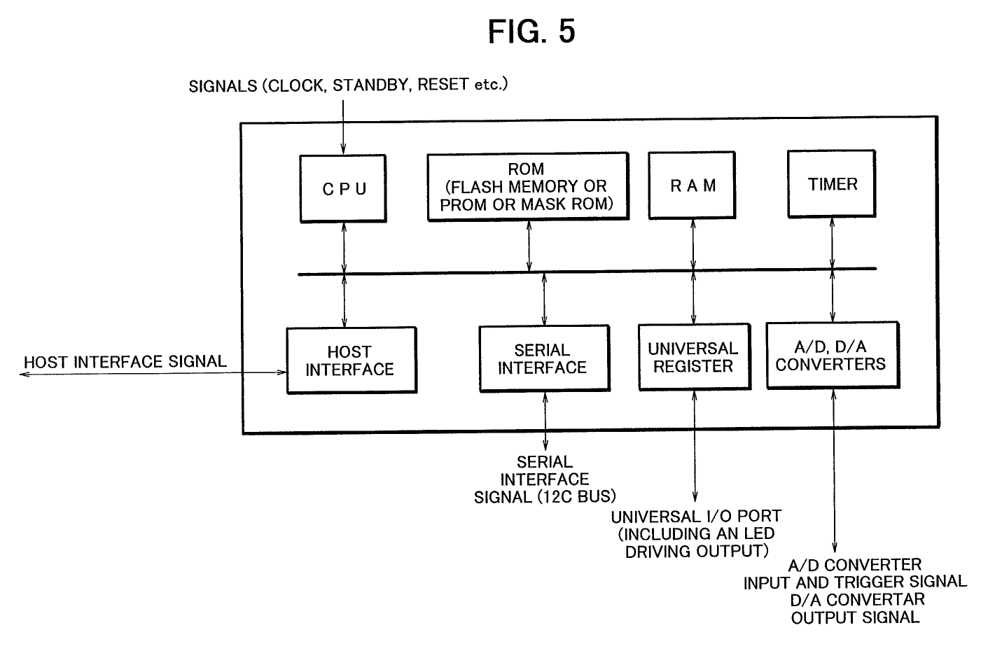

FIG. 5 is a block diagram illustrating in detail the power supply control integrated circuit (IC) 305 shown in FIG. 3. The power supply control integrated circuit (IC) 305 is composed of a one-chip microcomputer that includes a power supply control function, a sensor for detecting an input from a switch 318, a function to inform the CPU 301, a HOST interface function (for data communication with the CPU), a serial interface function (IC control interface in the TV function block), a universal register, a CPU, a RAM and a ROM, etc.

An information processing device with a TV function according to an aspect of the present invention will now described below.

### Embodiment 1

When the power supply for the TV function block was recognized as turned ON, settings necessary for start control are written in the universal register of the power supply control IC 305 by using a writing tool. A tool allowing the user to input necessary settings is prepared as an application of the information processing device.

If the user did not recognize the above, the start control is conducted according the default settings.

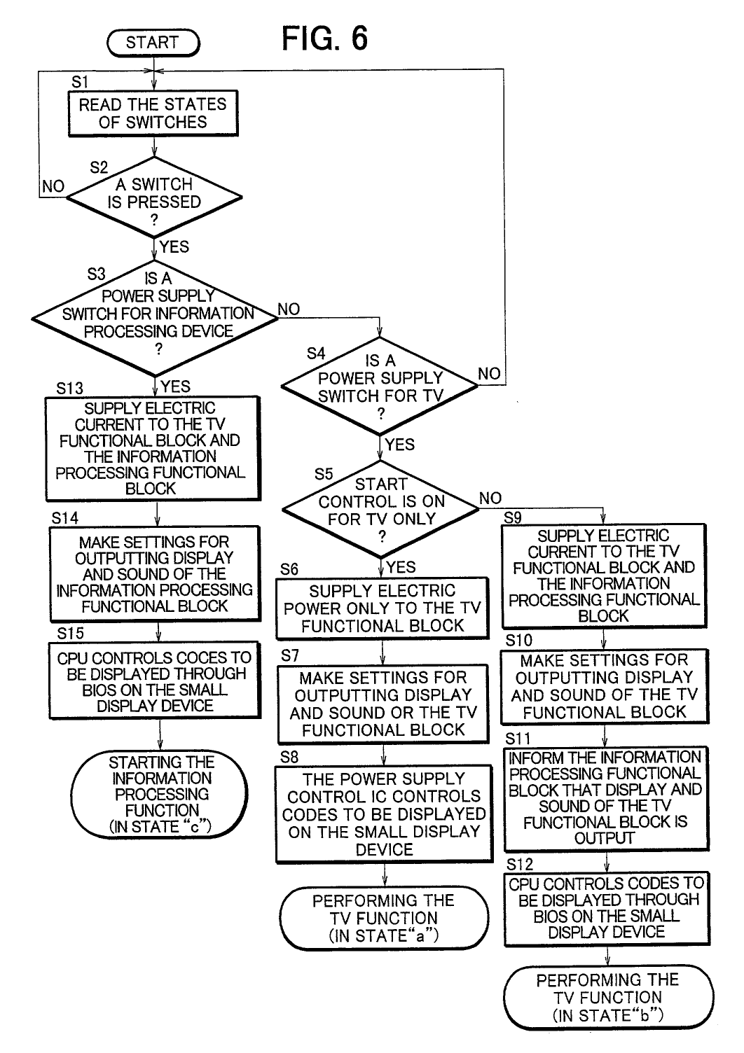

FIG. 6 is a flowchart illustrating the procedure of the information processing device with a TV function according to the present invention.

The power supply control IC 305 always observes whether the SW 318 is pressed or not (Steps S1 and S2).

When the power supply is turned ON, the power supply control IC 305 senses that one of switch buttons SW 318 was selected by the user and discriminates that the switch button pressed by the user is for the information processing device or for the TV (Steps S3 and S4).

When the TV power supply was recognized as pressed and the start control is turned ON only for the TV (Step S5), the power supply control IC 305 controls the power supply to apply the electric current to the TV function block (Step S6). It sets the TV tuner 311 and the NTSC decoder 312 to realize the TV function, and sets the display controller 315 and the amplifier 313 to output video and sound data for TV function block (Step S7). At this time, the sound GATE 314 and GATE 316 are controlled not to send any signal to the information processing function block.

In this case, the power supply control IC 305 encodes an indication of the power OFF state for the information processing function block (using, e.g., SHIFT JIS code) and transmits the code to the display controller 315.

The display controller 315 develops the received code on a bitmap, using its internal font memory, and outputs display data such as characters and symbols to the small display device 321 (Step S8, in state “a”).

If the discrimination result in Step S4 indicates that the TV power supply was selected and the start control was turned ON not only for the TV function block and also for the information processing function block (Step S5), the power supply control IC 305 supplies electric current to both the TV function block and the information processing function block (Step S9). It drives the TV function block, sets the TV tuner 311 and the NTSC decoder 312 to realize the TV function, and sets the display controller 315 and the amplifier portion 313 to output video and sound data for TV function block (Step S10).

At this time, the power supply control IC 305 controls the sound GATE 314 and GATE 316 to send a signal to the information processing function block and informs the information processing function block that display data and sound data is output for the TV function block (Step S11).

In this instance, the CPU 301 starts the processing operation by using the BIOS 304, through the CHIP SET 302 and the power supply control IC 305, encodes an indication of the operation start of the information processing function block according to the program in the BIOS 304 (using, e.g., SHIFT JIS code) and transmits the code to the display controller 315.

The display controller 315 develops the received code on a bitmap, using its internal font memory, and outputs display data such as characters and symbols to the small display device 321 (Step S12).

The BIOS 304 is programmed to transmit a code denoting “completion of starting the BIOS of the information processing device” before transferring the control to the operation system (OS)(State “b”).

In this instance, any application to be executed after driving the operation system may be also programmed so that it can operate the small display device like the BIOS 304.

If the discrimination result in Step S3 is the power supply of the information processing device (Step S3), the power supply control IC 305 causes the power supply system to supply electric current to both the TV function block and the information processing function block (Step S13) and then sets the display controller 315 to output the display and sound of the information processing function block (Step S14).

In this case, similarly to the state “b”, the CPU 301 may operate and display the codes on the small display device 321 in accord with the BIOS program (Step S15, State “c”).

When the result of discrimination by the power supply control IC 305 indicates the power supply was turned ON for the information processing device, the CPU 301 may control the power supply control IC 305 not to send the codes to the small display device 321.

As described above, the codes are sent to the display controller 315 to develop the code on a bitmap therein. By doing this, the amount of display data to be transferred can be saved, and, therefore, the amount of data to be processed by the power supply control IC 305 and CPU 301 is reduced.

### Embodiment 2

To control codes to be displayed on the small display device 321, there may be two cases, one is code control by the power supply control IC 305 and the other is code control by the CPU 301.

The case of controlling the codes by the power supply control IC 305 corresponds to the state “a”0 shown in FIG. 6. In case of the states “b” and “c” (other than the state “a”), the code control is conducted by the CPU 301.

In the case of the code control by the power supply control IC 305, the information processing function block is not supplied with power supply and only the TV function block is working. Information such as a channel number, sound volume, input source, etc. is managed by the power supply control IC 305.

The channel information can also be managed by the power supply control IC 305 by such provision that the information processing function block writes the received channel information in both the storage device 308 and a non-volatile memory provided for storing the channel information in the TV function block.

The power supply control IC 305 converts the channel number and channel information into codes displayable (e.g., SHIFT JIS code) and sends the codes to the display controller 315.

The display controller 315 develops the received codes into bitmap data internally and displays the codes on the small display device 321.

For example, “6ch” (Channel No. 6) can be displayed on the small display device 321 by sending three codes “6”, “c” and “h” instead of bitmap data of “6ch”.

On the other hand, the channel number and the channel information are managed by the information processing function block while the block is working.

By using an application, the CPU 301 converts the channel number and channel information into the displayable codes (e.g., SHIFT JIS code) and sends the codes through the power supply control IC 305 to the display controller 315.

In the same way as described above, the display controller 315 develops the received codes into bitmap data internally for displaying the codes on the small display device 321.

When the channel number was changed by using SW 318 in the state “a” shown in FIG. 6 or by using either the input device 317 or the SW 318 in the states “b” and “c”, the power supply control IC 305 or the CPU 301 converts the new channel number and new channel information into displayable codes and sends the new codes to the display controller 315 that in turn develops the codes on a bitmap therein and displays the codes on the small display device 321.

### Embodiment 3

When the information processing function block is not supplied with electric current and only the TV function block is working, the power supply control IC 305 manages and converts input source information into displayable codes (e.g., SHIFT JIS code). Then, it sends the codes to the display controller 315 that in turn develops the received codes on a bitmap therein and displays the codes on the small display device 321.

For example, “Video1” can be displayed on the small display device 321 by sending six codes “V”, “i”, “d”, “e”, “o” and “l” instead of bitmap data of “Video1”.

On the other hand, the input source information is managed in the information processing function block while the information processing function is working.

By using an application, the CPU 301 converts the input source information into the displayable codes (e.g., SHIFT JIS code) and sends the codes through the power supply control IC 305 to the display controller 315. In the same way as described above, the display controller 315 develops the received codes on a bitmap therein and displays the codes on the small display device 321.

When the input source was changed by using SW 318 in the state “a” shown in FIG. 6 or by using either the input device 317 or the SW 318 in the states “b” and “c”, each of power supply control IC 305 and the CPU 301 converts the input source information into displayable codes and sends the codes to the display controller 315 that in turn develops the codes on a bitmap therein and displays the codes on the small display device 321.

### Embodiment 4

When the information processing function block is not supplied with electric current and only the TV function block is working, the power supply control IC 305 manages and converts sound volume information into displayable codes (e.g., SHIFT JIS code) and sends the codes to the display controller 315.

The display controller 315 develops the received codes on a bitmap internally and displays the codes on the small display device 321.

For example, a 4-stage sound volume in the form of “▪▪▪▪” can be displayed by sending 4 codes “▪”, “▪”, “▪” and “▪” instead of bitmap data of “▪▪▪▪”.

It is also allowed to send codes “V”, “O”, “L” and “4”.

On the other hand, the sound volume information is managed in the information processing function block while the information processing function block is working. By using an application, the CPU 301 converts the input source information into the displayable codes (e.g., SHIFT JIS code) and sends the codes through the power supply control IC 305 to the display controller 315. In the same way as described above, the display controller 315 develops the received codes on a bitmap therein and displays the codes on the small display device 321.

When the input source was changed by using SW 318 in the state “a” shown in FIG. 6 or by using either the input device 317 or the SW 318 in the states “b” and “c”, the power supply control IC 305 or the CPU 301 converts the sound volume information into displayable codes and sends the new codes to the display controller 315 that in turn develops the codes on a bitmap therein and displays the new codes on the small display device 321.

### Embodiment 5

The display content can be changed by using SW 318 in the state “a” shown in FIG. 6 or by using either the input device 317 or the SW 318 in the states “b” and “c” in which the information processing function block is working.

In the state “a”, when a specified button of SW318 is pressed for selecting a specified display content, the power supply control IC 305 detects the pressed button and, as described for the above embodiments 1-4, sends the codes corresponding to the selected content to the display controller 315 that in turn develops the received codes on a bitmap therein and displays the codes on the small display device 321.

In the states “b” and “c”, when a specified button of SW 318 is pressed for selecting a specified display content, the power supply control IC 305 senses the pressed button and informs the information processing function block of that fact. The CPU 301 recognizes the information through the CHIP SET 302.

When the user selected a specified display content by using the input device 317, the CPU 301 through the other circuit 310 and the CHIP SET 302 recognizes the user's selection. After the recognition of the user's selection by the CPU 301, the codes corresponding to the selected display content is selected, as described above for the embodiments 1-4, and sent through the CHIP SET 302 and the power supply control IC 305 to the display controller 315 that in turn develops the received codes on a bitmap therein and displays the codes on the small display device 321.

The advantages of the invention are as follows:

According to the present invention, it is possible to display the operating state and the starting state of an information processing device can be displayed on a separate small display means while a TV picture is displayed on a main screen. This enables the user to see the current state of the information processing device without impairing the TV picture currently displayed on the main display screen, thus increasing the user's convenience.

Furthermore, according to the present invention, it is possible to separately indicate a channel number and channel information such as a TV channel, EPG etc. without impairing any image displayed on a main display screen in case when a TV program is displayed on the main screen or it is recorded by using a TV function while an image of the information processing device is displayed on the main screen.

Furthermore, according to the present invention, it is also possible to separately present input source information on a separate screen without impairing any image displayed on a main display screen in case when a TV picture is displayed on a main display screen or it is recorded by using a TV function while an image of the information processing device is displayed on the main screen.

In addition, according to the present invention, it is possible to separately present sound volume information without impairing any image displayed on a main display screen in case when a TV picture is displayed on the main screen or it is recorded by using a TV function while an image of the information processing device is displayed on the main screen.

Finally, according to the present invention, it is possible to separately present the operating state and the starting state of the information processing device, TV channel number and EPG information, input source information, sound volume information, all of which can be selectively changed by the user, without impairing any image displayed on a main display screen in case when a TV picture is displayed on the main screen or it is recorded by using a TV function while an image of the information processing device is displayed on the main screen, thus increasing the user's convenience.

1. An information processing device having television display function and provided with a small display device in addition to a display device for the information processing device, wherein, when a power supply is turned ON, a TV picture is displayed on the display device and TV sound is output, an operating state and a starting state of the information processing device is displayed on the small display device.

2. An information processing device having a TV display function and provided with a small display device in addition to a display device for information processing device, wherein a currently selected TV channel number and TV channel information is displayed on the small display device.

3. An information processing device having a TV display function and provided with a small display device in addition to a display device for the information processing device, which possesses a function of handling plural input sources for TV output and a function of displaying information of a currently selected input source out of the plural input sources, on the small display device.

4. An information processing device having a TV display function and provided with a small display device in addition to a display device for the information processing device, wherein TV sound volume information is displayed on the small display device.

5. An information processing device having a TV display function and provided with a small display device in addition to a display device for the information processing device, which is further provided with function for selecting a content of information to be displayed on the small display device, wherein an operating state and a starting state of the information processing device, a currently selected TV channel number and TV channel information, a currently selected input source and TV sound volume information are selectively displayed on the small display device.
